(19) United States
(12) Patent Application Publication
(10) Pub. No.: US 2025/0148190 A1
(43) Pub. Date: May 8, 2025

(54) Appearance-Conserving Document Semantic Enhancement

(71) Applicant: Corefiling S.A.R.L., Capellen (LU)

(72) Inventors: Jonathan Siddle, Long Hanborough (GB); Mark Goodhand, Oxford (GB); Ben Russell, Wallingford (GB); Nicolas Duvauchel, Marston (GB); Ethan Bishop, Reading (GB)

(21) Appl. No.: 18/503,592

(22) Filed: Nov. 7, 2023

(51) Int. Cl. G06F 40/151

(52) U.S. Cl. CPC G06F 40/151

(57) ABSTRACT

A computer implemented system and method automatically transform an original document (such as an HTML or XHTML document) into a transformed document, such that the transformed document includes elements which better represent the semantics of the original document, while having minimal impact on the document's rendered appearance. The transformed document may also be smaller, more practical to use, and more amenable to automated processing than the original document.

### BACKGROUND

The ESEF (European Single Electronic Format) mandate is a regulatory requirement in the European Union that mandates the digital format in which publicly-listed companies must prepare and submit their annual financial reports, with the goal of making financial statements more accessible and easier to analyze and compare. For example, the ESEF mandate requires that annual financial reports be prepared in the inline XBRL (eXtensible Business Reporting Language) format (iXBRL), which is an extension to XHTML (eXtensible Hypertext Markup Language) that allows text to be marked up against a set of numeric and non-numeric terms defined in an extensible taxonomy.

Originally, the XHTML used by Inline XBRL documents submitted to the HMRC (Her Majesty's Revenue and Customs) in the UK and the SEC (Securities and Exchange Commission) in the US were minimally-styled and contained markup which accurately represented the documents' semantics. As a result of the recent ESEF mandate, however, iXBRL documents have replaced highly-styled PDF documents for annual financial reports produced by European-listed companies. The XHTML used in such iXBRL reports makes heavy use of Cascading Style Sheets (CSS) to precisely position XHTML elements on pages in order to match the traditional printed layout. Typically, the XHTML in such iXBRL filings is produced by automatically converting ePub documents (produced using tools such as Adobe InDesign) or PDF documents (with the aid of libraries such as pdf2htmlEX) into highly-styled XHTML.

Although renderings of such XHTML documents tend to be faithful to the original layout of the documents from which they were derived, they often do not convey the meaning of their content in a way that is easy for computers to interpret accurately. For instance, instead of using specific tags that convey the semantics of the documents' contents explicitly (such as an <h1> tag for a main header or a <table> tag for a table), the XHTML generated in the manner described above often uses absolutely-positioned tags, such as <div> and <span> tags, that appear in the wrong order and which do not convey the semantics of the tagged content clearly.

Furthermore, sometimes the XHTML code is made overly complex by the use of many nested HTML tags that do not convey any useful information. This excessive complexity, or “bloat,” can cause at least two problems. First, bloated XHTML code can be very large (e.g., 200 MB), thereby reducing rendering performance. Second, such code can create accessibility problems with such documents, making them more difficult for people using screen readers and other assistive technologies to navigate.

What is needed, therefore, are improved techniques for generating documents that comply with the mandate and which do not have the problems described above.

### SUMMARY

A computer implemented system and method automatically transform an original document (such as an HTML or XHTML document) into an optimized document, such that the transformed document includes elements which better represent the semantics of the original document, while having minimal impact on the document's rendered appearance. The transformed document may also be smaller, more practical to use, and more amenable to automated processing than the original document.

Other features and advantages of various aspects and embodiments of the present invention will become apparent from the following description and from the claims.

### BRIEF DESCRIPTION OF THE DRAWINGS

FIG. 1 is a dataflow diagram of a system for optimizing the content of documents (e.g., XHTML and HTML documents) with minimal effect on the rendered appearance of such documents according to one embodiment of the present invention.

FIG. 2. is a flowchart of a method performed by the system of FIG. 1 according to one embodiment of the present invention.

FIG. 3 illustrates a sequence of applications of transformations to input and output documents, renderings of the resulting transformed documents, and comparisons of the resulting images performed by an optimization engine according to one embodiment of the present invention.

### DETAILED DESCRIPTION

A computer implemented system and method automatically transform an original document (such as an HTML or XHTML document) into a transformed document, such that the transformed document includes elements which better represent the semantics of the original document, while having minimal impact on the document's rendered appearance. The transformed document may also be smaller, more practical to use, and more amenable to automated processing than the original document. Although some techniques disclosed herein may be motivated by the ESEF mandate, such techniques may be applied more generally to any of a variety of documents, such as reports filed in compliance with a range of regulatory programs, including those that address ESG (environmental, social, and governance) reporting.

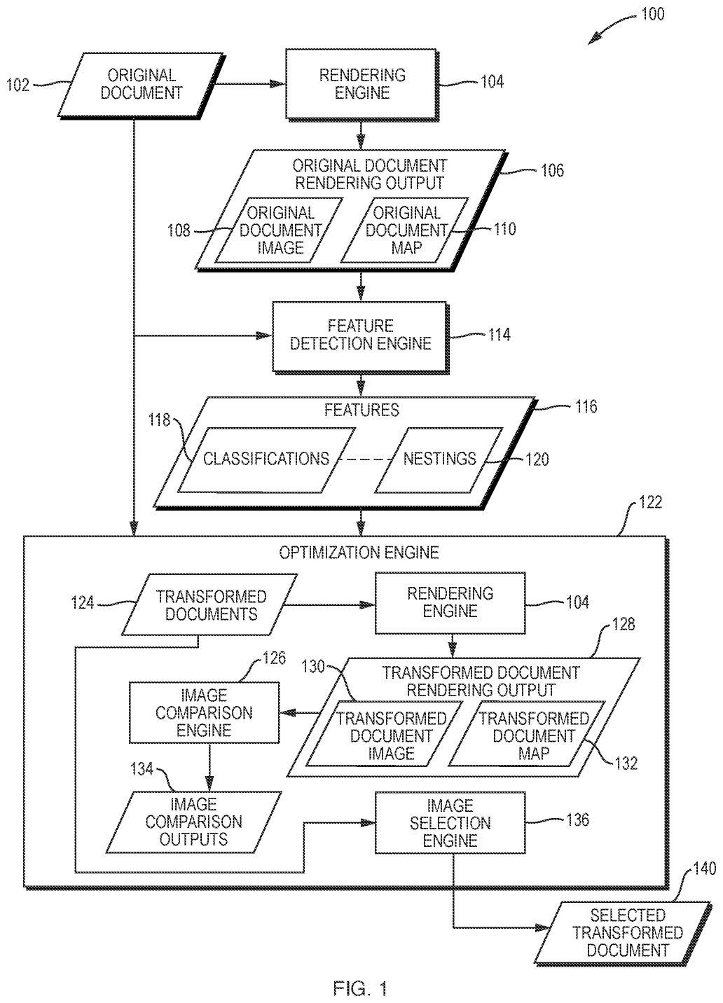

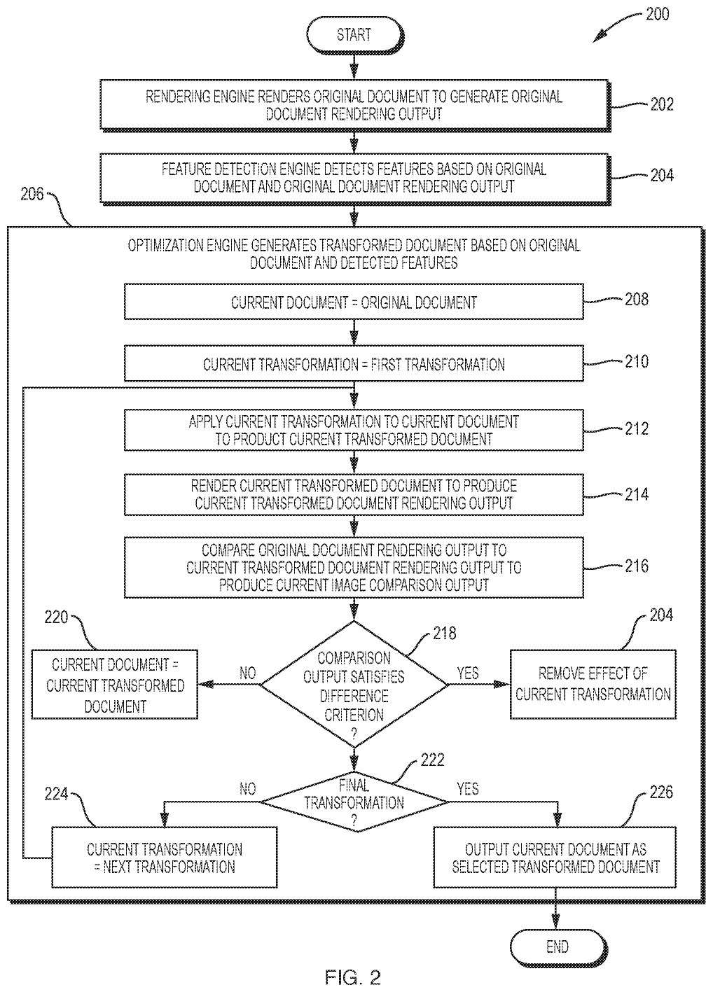

Referring to FIG. 1, a dataflow diagram is shown of a system 100 for improving an original document 102 according to one embodiment of the present invention, such as by creating a modified version of the original document 102 which is more practical to use, more accessible, and more amenable to automated processing than the original document 102, while having minimal impact on the rendered appearance of the original document 102. Referring to FIG. 2, a flowchart is shown of a method 200 that is performed by the system 100 according to one embodiment of the present invention.

The original document 102 may be any of a variety of types of documents. For example, the original document 102 may be an HTML document or an XHTML document. As particular examples, the original document 102 may be an XBRL document, such as an iXBRL document. Although the HTML, XHTML, and iXBRL are provided as particular examples of document formats, these are merely examples and do not constitute limitations of the present invention. More generally, the original document 102 may have any suitable format. The original document 102 may, for example, have a format that is developed in the future, such as a successor format to Inline XBRL or another format that mixes data markup with presentational instructions.

The original document 102 may have been created in any of a variety of ways, such as manually, by being automatically converted from an ePub document (e.g., using a tool such as Adobe InDesign), or by being automatically converted from a PDF document (e.g., using a library such as pdf2htmlEX). Although the original document 102 may be of any size and have any content, embodiments of the present invention may have particular benefits when the original document 102 is large (e.g., 100 MB or more) and/or contains unnecessarily non-semantic tags (e.g., <div> and/or <span> tags, where <table>, <tr>, and <td> tags would be more appropriate).

The original document 102 is an example of what is referred to herein as “non-optimized.” This is because the original document 102 may be formatted in ways that focus primarily on visual characteristics, to the detriment of semantic characteristics. As will be described in more detail below, the system 100 processes the original document 102 to generate a transformed document 150, which is an example of an “optimized” document, as that term is used herein. This is because the transformed document 150 may be formatted in ways that represent the semantics of the transformed document 150 (and, hence, of the original document 102), while having a minimal impact on the visual appearance of the document content. More specifically, and as will be made clear from the description below, the transformed document 150 may be rendered to produce visual output that differs minimally from the visual output that is produced when the original document 102 is rendered. More generally, the transformed document 150 may be more practical to use, more accessible, and more amenable to automated processing than the original document 102.

The system includes a rendering engine 104. The rendering engine 104 receives the original document 102 as input and generates, based on the original document 102, output that is referred to herein as original document rendering output 106 (FIG. 2, operation 202). The original document rendering output 106 may include, for example, an image (referring to herein as the original document image 108) that the rendering engine 104 generates by rendering the original document 102 in any of a variety of known ways. The original document 102 may include a plurality of element identifiers, each of which identifies a corresponding element in the original document 102. The original document rendering output 106 may include a map 110 (referred to as the original document map 110) which includes, for each of the plurality of element identifiers in the original document 102, a mapping from that element identifier (which identifies a corresponding element) to a corresponding location of the rendered element in the original document image 108. Each such location may, for example, take the form of x-y coordinates of the bounding rectangle of the rendered element. The map 110 may take any of a variety of forms, such as text.

The rendering engine 104 may be implemented in any of a variety of ways, such as by using a headless browser (e.g., Chrome) driven by a library (e.g., Puppeteer) that is capable of controlling the headless browser to render the original document 102 to produce the original document image 108.

Although not explicitly shown in FIG. 1, the original document rendering output 106 may include additional data relating to the original document 102 and/or the rendering of the original document 102, such as the time that elapsed during the rendering of the original document 102 by the rendering engine 104.

The system 100 also includes a feature detection engine 114, which receives the original document 102 and some or all of the original document rendering output 106 as input (e.g., only the original document image 108 or both the original document image 108 and the original document map 110), and classifies each of some or all of the elements E in the original document 102 according to semantics inferred by the feature detection engine 114 from the position of element E relative to other elements in the original document image 108 (FIG. 2, operation 204). For example, the feature detection engine 114 may infer that elements arranged in a rectangular array form a table, and that each rectangle (and its contents) represent a cell in that table. Examples of categories that the feature detection engine 114 may assign to elements in the original document 102 include Document, Page, Page Header, Page Footer, Page Body, Column, Paragraph, Table, Table Row, Table Cell, List, List Item, Image, and Text. The output of the feature detection engine 114 is a set of features 116, which may include the classifications 118 just mentioned.

Such categories (e.g., Document, Page, Page Header, etc.) are examples of what are referred to herein as “components.” Such components are distinct document features which are identified by embodiments of the present invention and, as described in more detail below, transformed into elements. “Elements,” also referred to as “tags,” are defined by standards such as HTML and iXBRL.

The semantic components just mentioned (e.g., Document and Page) may follow defined nesting rules. For example, Table Cells are nested within Table Rows, which are nested within Tables. As another example, Documents may optionally be divided into Pages (which, therefore, nest within Documents), each of which has a Page Body, an optional Page Header, and an optional Page Footer. Page Bodies may directly contain Paragraphs and/or Tables, or may be first divided into columns. As this implies, Paragraphs, Tables, and Columns may nest within Page Bodies, and Paragraphs and Tables may nest within Columns, which may nest within Page Bodies. As yet another example, Image and Text components may nest within Page Header, Page Footer, Table Cell, and Paragraph components.

The feature detection engine 114 may determine (and generate) nestings 120 for the components specified by the classifications 118, based on the original document 102, the original document rendering output 106, and the classifications 118, such that the nestings 120 represent how components represented by the classifications 118 nest within each other. For example, as described above, the original document 102 may include non-semantic elements, such as <span> and/or <div> elements. The feature detection engine 114 may generate the classifications 118, which specify semantic elements, such as Document, Page, and Table. The feature detection engine 114 may also generate the nestings 120, which may specify ways in which the generated semantic elements nest within each other. The feature detection engine 114 may generate such nestings 120 in any of a variety of ways. For example, the feature detection engine 114 may generate the nestings 120 using a Large Language Model (LLM), such as Llama-2, fine-tuned with representative XHTML inputs. Regardless of how the feature detection engine 114 generates the nestings 120, the nestings 120 represent how the components represented by the classifications 118 nest within each other.

The system 100 also includes an optimization engine 122, which receives the original document 102 and the features 116 (and, optionally, some or all of the original document rendering output 106) as inputs, and applies a series of transformations to the original document 102 to produce a transformed document 140 (FIG. 2, operation 206). To produce the transformed document 140, the optimization engine 122 may, for example, generate a plurality of transformed documents 124, and select one of the plurality of transformed documents 124 as the transformed document 140. As will be described in more detail below, each transformation applied by the optimization engine 122 (to the original document 102, and to transformations of the original document 102) produces a distinct one of the plurality of transformed documents 124. Each of the plurality of transformed documents 124 may have any of the properties disclosed herein in connection with the original document 102. For example, some or all of the plurality of transformed documents 124 may be of the same document type as the original document 102 (e.g., HTML, XHTML, XBRL, or iXBRL).

The optimization engine 122 may apply any of a variety of transformations to the original document 102 to generate the plurality of transformed documents 124. The set of transformations applied by the optimization engine 122 may include transformations which are similar to each other or which differ from each other in any of a variety ways. One or more of the transformations applied by the optimization engine 122 may, for example, be hard-coded to handle known patterns of input (such as pdf2htmlEX). A hard-coded transformation may, for example, handle the conversion of images that are base64-encoded using data-scheme URLs to standalone images, appropriately de-duplicated using content hashes.

One or more of the transformations applied by the optimization engine 122 may, for example, be hard-coded to handle known patterns of output (e.g., known optimizations for browsers, including CSS to improve rendering performance, as suggested in the Inline XBRL Rendering Performance Working Group Note from XBRL International).

As another example, one or more transformations performed by the optimization engine 122 may not be hard-coded, but may instead be performed by one or more machine learning or artificial intelligence components, such as Llama-2, trained on previous optimizations.

The optimization engine 122 may apply the transformations in any of a variety of orders. For example, the system 100 may prescribe a particular order, and the optimization engine 122 may apply the transformations in the prescribed order. As another example, for any particular set of transformations, the optimization engine 122 may apply the transformations in the set in an arbitrary order.

The system 100 also includes an image comparison engine 126. Regardless of the form of the transformations, at each stage, the input document to the optimization engine 122 and the output document from the optimization engine 122 are rendered by the rendering engine 104, and the resulting rendered images are provided as inputs to the image comparison engine 126, which compares its input images and produces image comparison output representing the results of the comparison. (Note that the rendering engine 104 is shown twice in FIG. 1 merely for ease of illustration. In practice, the system 100 may include a single instance of the rendering engine 104, which may perform the role of both of the instances of the rendering engine 104 shown in FIG. 1.) The image comparison output may, for example, be in the form of a numeric value quantifying the difference between the input images to the image comparison engine 126. As an example, the image comparison engine 126 may use the “pixelmatch” image comparison library available at https://github.com/mapbox/pixelmatch. The image comparison outputs 134 shown in FIG. 1 are the outputs that result from performing such comparisons on a plurality of pairs of images.

As shown in FIG. 1, the plurality of transformed documents 124 are provided as inputs to the rendering engine 104, which generates, for each of the plurality of transformed documents 124, corresponding transformed document rendering output 128, which may have any of the properties disclosed herein in connection with the original document rendering output 106. For example, in connection with a particular one of the plurality of transformed documents 124, the transformed document rendering output 128 may include a transformed document image 130, which may be generated by the rendering engine 104 by rendering the transformed document in any of a variety of known ways. The transformed document rendering output 128 may also include a transformed document map 132, which includes, for each of the plurality of element identifiers in the transformed document, a mapping from that element identifier (which identifies a corresponding element) to a corresponding location of the rendered element in the transformed document image 130. The transformed document map 132 may otherwise have any of the properties disclosed herein in connection with the original document map 110.

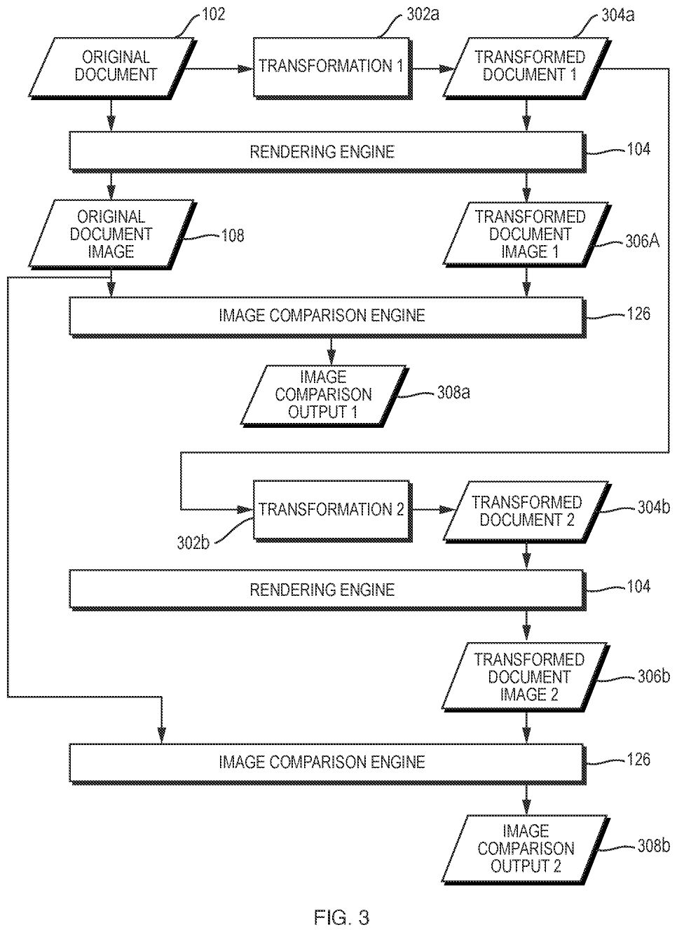

The optimization engine 122 may generate the transformed document 140 by applying a sequence of transformations, first to the original document to produce a first transformed document, and then to the first transformed document to produce a second transformed document, and so on. This process is illustrated in FIG. 2, and in FIG. 3, which illustrates an example sequence of applications of transformations to input and output documents, renderings of the resulting transformed documents, and comparisons of the resulting images performed by the optimization engine 122 according to one embodiment of the present invention.

For example, the system 100 and method 200 may be configured with a particular ordered set of transformations. The method 200 of FIG. 2 may begin with: (1) the original document 102 being treated as what is referred to herein as the “current document” (FIG. 2, operation 208); and (2) the first transformation in the ordered set of transformations being treated as the “current transformation” (FIG. 2, operation 210). The optimization engine 122 may apply the current transformation to the current document to produce a document that is referred to herein as the “current transformed document” (FIG. 2, operation 212). For example, FIG. 3 illustrates that the optimization engine 122 may apply a first transformation 302a to the original document 102, thereby generating a first transformed document 304a, which is an example of operation 212 in FIG. 2.

The rendering engine 104 may render the current transformed document to produce what is referred to herein as the “current transformed document rendering output,” which may have some or all of the properties of the transformed document rendering output 128 shown in FIG. 1 (FIG. 2, operation 214). The rendering engine 104 may render the original document to produce the original document rendering output 106, or the optimization engine 122 may receive a previously-rendered version of the original document rendering output 106, thereby eliminating the need to render the original document 102 again as part of the method 200 of FIG. 2. (In other words, the optimization engine 122 may reuse the same previously-generated version of the original document rendering output 106 in all iterations of the method 200.) As a particular example, referring again to FIG. 3, the rendering engine 104 may render the first transformed document 304a to generate a first transformed document image 306a.

The image comparison engine 126 may compare the original document rendering output 106 (or just the original document image 108) to the current transformed document rendering output (or just the current transformed document image) to generate current image comparison output (FIG. 2, operation 216). For example, referring again to FIG. 3, the image comparison engine 126 may compare the original document image 108 and the first transformed document image 306a to generate first image comparison output 308a. (As in the case of FIG. 1, multiple instances of the rendering engine 104 and the image comparison engine 126 are shown in FIG. 3 merely for ease of illustration. In practice, a single instance of the rendering engine 104 and a single instance of the image comparison engine 126 may perform their respective functions shown in FIG. 3.)

The optimization engine 122 may determine, based on the first image comparison output 308a, whether the first transformed document image 306a differs too much from the original document image 108, where “too much” may, for example, be measured by reference to a predetermined threshold amount (FIG. 2, operation 218). For example, referring again to the example of FIG. 3, the optimization engine 122 may determine that the first transformed document image 306a differs too much from the original document image 108 if the first image comparison output 308a is greater than the predetermined threshold amount. More generally, the optimization engine 122 may determine whether the first transformed document image 306a differs too much from the original document image 108 by determining whether the first image comparison output 308a satisfies some difference criterion.

In response to determining that the first transformed document image 306a differs too much from the original document image 108, the optimization engine 122 may remove the effect of the current transformation in any of a variety of ways (FIG. 2, operation 220), such as by performing any one or more of the following:
Discarding the current transformed document, or otherwise not using the current transformed document in subsequent iterations of the method 200 (and thereby effectively discarding the effect of the current transformation on the current document). In the example of FIG. 3, this would result in the next iteration of the process being applied to the previous document in the sequence (e.g., the original document 102), rather than to the current document in the sequence (e.g., the first transformed document image 306a).
Eliminating the transformation that resulted in the unacceptably large deviation (which would be the first transformation 302a in this case) from the set of transformations that is applied at any point in the current instance of the process of FIG. 3. (In other words, if the system 100 performs the process shown in FIG. 3 again, either to the original document 102 or to another document, the system 100 may apply a previously-eliminated transformation during that process.)
Eliminating the transformation that resulted in the unacceptably large deviation (which would be the first transformation 302a in this case) from the set of transformations that is used by the system 100 in connection with any input document.

If the first transformed document image 306a does not differ too much from the original document image 108, then the method 200 may set the current document to the current transformed document (e.g., to the first transformed document image 306a in the current iteration of FIG. 3), so that the method 200 is ready to perform the next transformation (if any) to that document in the next iteration of the method 200 (if any) (FIG. 2, operation 220). Note that, if the first transformed document image 306a does differ too much from the original document image 108, then the method 200 does not set the current document to the current transformed document, so that the next iteration of the method 200 (if any) is applied again to the same current document as in the previous iteration of the method 200. This achieves elimination of the effect of the current transformation on the current document.

The optimization engine 122 determines whether the current transformation is the final transformation in the set of transformations to be applied (FIG. 2, operation 222). If the current transformation is not the final transformation, then the optimization engine 122 sets the current transformation to the next transformation in the ordered set of transformations (FIG. 2, operation 224), and returns to operation 212, so that operations 212 onward may be applied to the new current document, using the new current transformation.

For example, in the case of FIG. 3, the optimization engine 122 may apply a second transformation 302b to the first transformed document 304a, thereby generating a second transformed document 304b. The first transformation 302a may differ from the second transformation 302b in any of a variety of ways. The rendering engine 104 may render the second transformed document 304b to generate a second transformed document image 306b. The image comparison engine 126 may compare the original document image 108 to the second transformed document image 306b to generate second image comparison output 308b.

Although FIG. 3 only shows two transformations 302a-b and subsequent comparisons of the corresponding images, the process shown in FIG. 3 may be continued for any additional number of transformations applied in sequence in the manner shown in FIG. 3, by performing the method 200 of FIG. 2.

Once the method 200 applies the final transformation in the ordered set of transformations (FIG. 2, operation 222), the optimization engine 122 outputs the current document as the selected transformed document 140 (FIG. 2, operation 226). The effect of this may, for example, be to output the most recent transformed document that was not too different from the original document 102, as determined in operation 218 of the method 200. This is illustrated in FIG. 1 by an image selection engine 136, which selects one of the transformed documents 124 for output as the selected transformed document 140.

For example, returning to FIG. 3, if the optimization engine 122 generated transformed document 304a and transformed document 304b, and did not discard either of those documents, then the optimization engine 122 would output transformed document 304b as the selected transformed document 140. As another example, if the optimization engine 122 generated transformed document 304a and transformed document 304b, and discarded transformed document 304b, then the optimization engine 122 would output transformed document 304a as the selected transformed document 140.

Although any set of transformations may be applied by the process of FIG. 3, it may be useful to select transformations which, in combination, seek to minimize the size of the transformed documents 124, the rendering time as reported by the rendering engine 104, and the difference between the input and output renderings (as reflected in the image comparison outputs 134). The result of applying such transformations in the manner described herein is to output a selected transformed document 140

Embodiments of the present invention have a variety of advantages, such as the following.

In general, embodiments of the present invention automatically transform an original document (such as an HTML or XHTML document) into a transformed document, such that the transformed document is improved in a variety of ways relative to the original document. For example, relative to the original document, the transformed document may:
Better represent the semantics of the original document than the original document itself. For example, as explained above, many highly-styled iXBRL documents include tags (such as <div> and/or <span>) tags which do not represent the semantics of the document content clearly. The transformed document may, instead of or in addition to such non-semantic tags, including tags which better represent the semantics of the document content, such as tags specifying Document, Page Header, and Table components. Further, such tags in the transformed document may be nested within each other in ways that reflect the semantics of the document content, thereby further improving the semantic quality of the transformed document relative to the original document.
Be smaller than the original document. As described above, many XHTML documents used to satisfy the ESEF mandate are very large (e.g., up to 200 MB), which can result in a variety of problems, such as long download and rendering times. By producing a transformed document that has the improved properties disclosed herein and is smaller than the original document, embodiments of the present invention may enable the transformed document to be downloaded, stored, and rendered more efficiently than the original document.
Perform the above while having minimal, if any, impact on the document's rendered appearance. This may be achieved using the processes described above, which evaluate transformations on the original document for their ability to have minimal impact on the document's rendered appearance.
Be more practical to use than the original document. For example, if the transformed document has a simpler DOM structure than the original document, this will also provide a simpler tagging structure (iXBRL) than the original document, since fewer iXBRL tags would need to be split up to create valid selections. Furthermore, because the number of DOM elements is linked to the rendering time, a simpler DOM structure might improve the user experience by allowing for a greater frame rate when interacting with the page.
Be more amenable to automated processing than the original document. For example, tabular data elements that are stored in an explicit table structure (e.g., in “Table,” “TR,” and “TD” elements) can be more easily processed than elements that are stored in the form of absolutely-positioned “span” elements.
Have a more consistent structure than the original document. For example, the DOM document order in the original document may not match the relative positions of components in the rendering of the original document. As a particular example, the original document might include a first <div> element representing a first paragraph, followed by a second <div> element representing a second paragraph, but when that document is rendered, the first paragraph may appear after the second paragraph in the rendering. In contrast, the transformed documents generated by embodiments of the present invention may include content which appears in the same relative order in the document and in the rendering of the document.
Be easier for accessibility tools to consume. For example, most accessibility tools rely on the structure of the document, the types of elements the document, and the ARIA properties of such elements to generate meaningful output. The original document may contain elements, such as <div> and <span> elements, that have little semantic value, and which therefore do not enable most accessibility tools to generate semantically meaningful output. In contrast, the transformed document may contain semantically-meaningful elements, such as <H1>, <P>, and <Table> elements, which accessibility tools may use to generate semantically meaningful output.

In some embodiments, a method is performed by at least one computer processor executing computer program instructions stored in at least one non-transitory computer-readable medium. The method includes: (A) receiving an original document as input; (B) rendering the original document to produce an original document image; (C) applying an ordered plurality of transformations on the original document, thereby producing a plurality of transformed documents, wherein the applying includes rejecting any transformed documents whose rendered appearance satisfies a difference criterion relative to a rendered appearance of the original document; (D) identifying a final transformed document that was not rejected in the plurality of transformed documents; and (E) outputting the final transformed document.

Operation (B) may further include generating an original document map based on the original document, wherein the original document map includes, for each element identifier I of a corresponding element E in the original document, a mapping from element identifier I to a corresponding location of a rendering of element E in the original document image.

The method may further include: (F) before (C), generating, based on the original document and the original document rendering output, a plurality of features, the plurality of features including a plurality of classifications of a plurality of elements in the original document.

Generating the plurality of features may include: inferring semantics of the plurality of elements in the original document based on relative positions of the plurality of elements within the original document; and generating the plurality of features based on the inferred semantics of the plurality of elements.

Operation (F) may further include generating, based on the original document, the original document image, the original document map, and the plurality of classifications, a plurality of nestings of components specified by the plurality of classifications.

Operation (C) may include: (C)(1) setting a current document to the original document; (C)(2) for each transformation T in the ordered plurality of transformations: (C)(2)(a) applying transformation T to the current document to generate a current transformed document; (C)(2)(b) rendering the current transformed document to produce a current transformed document image; (C)(2)(c) comparing the original document image to the current transformed document image to produce current image comparison output; (C)(2)(d) only if the current image comparison output does not satisfy the difference criterion, then setting the current document to the current transformed document; and wherein (D) includes identifying the current document as the final transformed document.

Operation (C)(2)(b) may further include generating a current transformed document map based on the current transformed document, wherein the current transformed document map includes, for each element identifier I of a corresponding element E in the current transformed document, a mapping from element identifier I to a corresponding location of a rendering of element E in the current transformed document image.

The original document may be an XHTML document, and the final transformed document may be an XHTML document. The original document may be an HTML document, and the final transformed document may be an HTML document. The original document may be an IXBRL document, the final transformed document may be an IXBRL document, and meanings of iXBRL tags in the original document may be preserved in the final transformed document according to the iXBRL specification.

Operation (C)(2)(d) may include determining whether the current image comparison output satisfies the difference criterion, which may include determining whether the current image comparison output is greater than a predetermined threshold value.

In some embodiments, a system includes at least one non-transitory computer-readable medium having computer program instructions stored thereon, the computer program instructions being executable by at least one computer processor to perform a method. The method may include: (A) receiving an original document as input; (B) rendering the original document to produce an original document image; (C) applying an ordered plurality of transformations on the original document, thereby producing a plurality of transformed documents, wherein the applying includes rejecting any transformed documents whose rendered appearance satisfies a difference criterion relative to a rendered appearance of the original document; (D) identifying a final transformed document that was not rejected in the plurality of transformed documents; and (E) outputting the final transformed document.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention transform, render, and compare documents in computer-specific formats such as HTML and XHTML. Furthermore, embodiments of the present invention transform such documents automatically, render such documents automatically, compare the rendered documents to each other automatically, and iteratively evaluate such rendered documents based on the results of such comparisons automatically. All such functions are inherently rooted in computer technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored in at least one non-transitory computer-readable medium, the method comprising:
(A) receiving an original document as input;
(B) rendering the original document to produce an original document image;
(C) applying an ordered plurality of transformations on the original document, thereby producing a plurality of transformed documents, wherein the applying comprises rejecting any transformed documents whose rendered appearance satisfies a difference criterion relative to a rendered appearance of the original document;
(D) identifying a final transformed document that was not rejected in the plurality of transformed documents; and
(E) outputting the final transformed document.

2. The method of claim 1, wherein (B) further comprises generating an original document map based on the original document, wherein the original document map comprises, for each element identifier I of a corresponding element E in the original document, a mapping from element identifier I to a corresponding location of a rendering of element E in the original document image.

3. The method of claim 2, further comprising:
(F) before (C), generating, based on the original document and the original document rendering output, a plurality of features, the plurality of features including a plurality of classifications of a plurality of elements in the original document.

4. The method of claim 3, wherein generating the plurality of features comprises:
inferring semantics of the plurality of elements in the original document based on relative positions of the plurality of elements within the original document; and
generating the plurality of features based on the inferred semantics of the plurality of elements.

5. The method of claim 3, wherein (F) further comprises generating, based on the original document, the original document image, the original document map, and the plurality of classifications, a plurality of nestings of components specified by the plurality of classifications.

6. The method of claim 1, wherein (C) comprises:
(C)(1) setting a current document to the original document;
(C)(2) for each transformation T in the ordered plurality of transformations:
(C)(2)(a) applying transformation T to the current document to generate a current transformed document;
(C)(2)(b) rendering the current transformed document to produce a current transformed document image;
(C)(2)(c) comparing the original document image to the current transformed document image to produce current image comparison output;
(C)(2)(d) only if the current image comparison output does not satisfy the difference criterion, then setting the current document to the current transformed document; and
wherein (D) comprises identifying the current document as the final transformed document.

7. The method of claim 6, wherein (C)(2)(b) further comprises generating a current transformed document map based on the current transformed document, wherein the current transformed document map comprises, for each element identifier I of a corresponding element E in the current transformed document, a mapping from element identifier I to a corresponding location of a rendering of element E in the current transformed document image.

8. The method of claim 1, wherein the original document comprises an XHTML document, and wherein the final transformed document comprises an XHTML document.

9. The method of claim 1, wherein the original document comprises an HTML document, and wherein the final transformed document comprises an HTML document.

10. The method of claim 1, wherein the original document comprises an iXBRL document, wherein the final transformed document comprises an iXBRL document, and wherein meanings of iXBRL tags in the original document are preserved in the final transformed document according to the iXBRL specification.

11. The method of claim 1, wherein (C)(2)(d) comprises determining whether the current image comparison output satisfies the difference criterion, which comprises determining whether the current image comparison output is greater than a predetermined threshold value.

12. A system comprising at least one non-transitory computer-readable medium having computer program instructions stored thereon, the computer program instructions being executable by at least one computer processor to perform a method, the method comprising:
(A) receiving an original document as input;
(B) rendering the original document to produce an original document image;
(C) applying an ordered plurality of transformations on the original document, thereby producing a plurality of transformed documents, wherein the applying comprises rejecting any transformed documents whose rendered appearance satisfies a difference criterion relative to a rendered appearance of the original document;
(D) identifying a final transformed document that was not rejected in the plurality of transformed documents; and
(E) outputting the final transformed document.

13. The system of claim 12, wherein (B) further comprises generating an original document map based on the original document, wherein the original document map comprises, for each element identifier I of a corresponding element E in the original document, a mapping from element identifier I to a corresponding location of a rendering of element E in the original document image.

14. The system of claim 13, wherein the method further comprises:
(F) before (C), generating, based on the original document and the original document rendering output, a plurality of features, the plurality of features including a plurality of classifications of a plurality of elements in the original document.

15. The system of claim 3, wherein generating the plurality of features comprises:
inferring semantics of the plurality of elements in the original document based on relative positions of the plurality of elements within the original document; and
generating the plurality of features based on the inferred semantics of the plurality of elements.

16. The system of claim 14, wherein (F) further comprises generating, based on the original document, the original document image, the original document map, and the plurality of classifications, a plurality of nestings of components specified by the plurality of classifications.

17. The system of claim 12, wherein (C) comprises:
(C)(1) setting a current document to the original document;
(C)(2) for each transformation T in the ordered plurality of transformations:
(C)(2)(a) applying transformation T to the current document to generate a current transformed document;
(C)(2)(b) rendering the current transformed document to produce a current transformed document image;
(C)(2)(c) comparing the original document image to the current transformed document image to produce current image comparison output;
(C)(2)(d) only if the current image comparison output does not satisfy the difference criterion, then setting the current document to the current transformed document; and
wherein (D) comprises identifying the current document as the final transformed document.

18. The system of claim 17, wherein (C)(2)(b) further comprises generating a current transformed document map based on the current transformed document, wherein the current transformed document map comprises, for each element identifier I of a corresponding element E in the current transformed document, a mapping from element identifier I to a corresponding location of a rendering of element E in the current transformed document image.

19. The system of claim 12, wherein the original document comprises an XHTML document, and wherein the final transformed document comprises an XHTML document.

20. The system of claim 12, wherein the original document comprises an HTML document, and wherein the final transformed document comprises an HTML document.

21. The system of claim 12, wherein the original document comprises an iXBRL document, wherein the final transformed document comprises an iXBRL document, and wherein meanings of iXBRL tags in the original document are preserved in the final transformed document according to the iXBRL specification.

22. The system of claim 12, wherein (C)(2)(d) comprises determining whether the current image comparison output satisfies the difference criterion, which comprises determining whether the current image comparison output is greater than a predetermined threshold value.
